(19) United States
(12) Patent Application Publication
(10) Pub. No.: US 2012/0218294 A1
(43) Pub. Date: Aug. 30, 2012

(54) PROJECTION-TYPE IMAGE DISPLAY APPARATUS

(75) Inventors: Naoyuki NIMURA, Higashiosaka-shi (JP); Fuminori MIZUNO, Higashiosaka-shi (JP); Masutaka INOUE, Hirakata-shi (JP)

(73) Assignee: SANYO ELECTRIC CO., LTD., Moriguchi-shi (JP)

(21) Appl. No.: 13/403,271

(22) Filed: Feb. 23, 2012

(30) Foreign Application Priority Data
Feb. 25, 2011 (JP) 2011-040102

(51) Int. Cl. G09G 5/32; G09G 5/377; G03B 21/26

(52) U.S. Cl. 345/629; 353/30

(57) ABSTRACT

A projection-type image display apparatus projects an image on a projection plane, and includes a projection unit, an image capture unit, an ambient light detection unit, and a superimposed image generation unit. The projection unit projects an image on the projection plane through a lens. The image capture unit captures the image projected on the projection plane by the projection unit. The ambient light detection unit detects ambient light cast on the projection plane, from the image captured by the image capture unit. The superimposed image generation unit generates information about detection of ambient light detected by the ambient light detection unit, in the form of a superimposed image to be superimposed on the image projected on the projection plane.

This nonprovisional application is based on Japanese Patent Application No. 2011-040102 filed on Feb. 25, 2011 with the Japan Patent Office, the entire contents of which are hereby incorporated by reference.

### BACKGROUND OF THE INVENTION

1. Field of the Invention

The present invention relates to a projection-type image display apparatus, and particularly to a projection-type image display apparatus that includes an image capture unit capturing an image projected on a projection plane.

2. Description of the Related Art

In recent years, projection-type image display apparatuses have become mounted with a camera that captures an image projected on a projection plane to have an interactive capability of focusing an image to be projected on the projection plane based on the image captured by the camera, or producing, in the form of a superimposed image, a track of a pointing device whose image is captured by the camera. Thus, the projection-type image display apparatus involves a problem that the interactive capability does not properly function if ambient light is cast on the projection plane. Specifically, due to the influence of the ambient light, focusing fails or the track of the pointing device cannot be produced in the form of a superimposed image.

The conventional projection-type image display apparatus uses a pointing device having a light source that flashes on and off in predetermined cycles so as to distinguish the light from the light source and ambient light from each other and determine whether or not ambient light is cast on the projection plane. Thus, regarding the conventional projection-type image display apparatus, the position of the projection-type image display apparatus or the position of the projection plane is adjusted so that the ambient light distinguished by means of the pointing device is not cast on the projection plane.

The conventional projection-type image display apparatus, however, cannot determine whether or not ambient light is cast on the projection plane if the apparatus is not provided with the pointing device. Further, for the conventional projection-type image display apparatus, it is necessary to perform the operation of adjusting the position of the projection-type image display apparatus or projection plane so that ambient light is not cast on the projection plane, and thereafter using again the pointing device to determine whether or not there is ambient light cast on the projection plane. Namely the operation is complicated.

Further, regarding the conventional projection-type image display apparatus, if the position of the projection-type image display apparatus or projection plane cannot be adjusted for preventing ambient light from being cast on the projection plane, the influence of the ambient light cast on the projection plane on the interactive capability cannot be alleviated.

### SUMMARY OF THE INVENTION

According to an aspect of the present invention, a projection-type image display apparatus projects an image on a projection plane, and includes a projection unit, an image capture unit, an ambient light detection unit, and a superimposed image generation unit. The projection unit projects an image on the projection plane through a lens. The image capture unit captures the image projected on the projection plane by the projection unit. The ambient light detection unit detects ambient light cast on the projection plane, from the image captured by the image capture unit. The superimposed image generation unit generates information about detection of ambient light detected by the ambient light detection unit, in the form of a superimposed image to be superimposed on the image projected on the projection plane.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a configuration of a projection-type image display apparatus according to a first embodiment of the present invention.

FIG. 2 is a flowchart showing an operation of detecting ambient light by the projection-type image display apparatus according to the first embodiment of the present invention.

FIG. 3 is an exemplary diagram of a superimposed image displayed in step S204 by the projection-type image display apparatus according to the first embodiment of the present invention.

FIG. 4 is an exemplary diagram of a superimposed image displayed in step S205 by the projection-type image display apparatus according to the first embodiment of the present invention.

FIG. 5 is another exemplary diagram of the superimposed image displayed in step S205 by the projection-type image display apparatus according to the first embodiment of the present invention.

FIG. 6 is an exemplary diagram of an image displayed after undergoing image processing by an image processing unit of the projection-type image display apparatus according to the first embodiment of the present invention.

FIG. 7 is another exemplary diagram of an image displayed after undergoing image processing by the image processing unit of the projection-type image display apparatus according to the first embodiment of the present invention.

FIG. 8 is still another exemplary diagram of an image displayed after undergoing image processing by the image processing unit of the projection-type image display apparatus according to the first embodiment of the present invention.

FIG. 9 is an exemplary diagram of a superimposed image displayed in step S209 by the projection-type image display apparatus according to the first embodiment of the present invention.

FIG. 10 is a flowchart showing an operation of detecting ambient light by a projection-type image display apparatus according to a second embodiment of the present invention.

FIG. 11 is an exemplary diagram of a superimposed image displayed in step S307 by the projection-type image display apparatus according to the second embodiment of the present invention.

FIG. 12 is a block diagram showing a configuration of a projection-type image display apparatus according to a third embodiment of the present invention.

FIG. 13 is a flowchart showing an operation of detecting ambient light by the projection-type image display apparatus according to the third embodiment of the present invention.

FIG. 14 is an exemplary diagram of a superimposed image displayed in step S407 by the projection-type image display apparatus according to the third embodiment of the present invention.

### DESCRIPTION OF THE PREFERRED EMBODIMENTS

In the following, embodiments of the present invention will be described in detail with reference to the drawings.

### First Embodiment

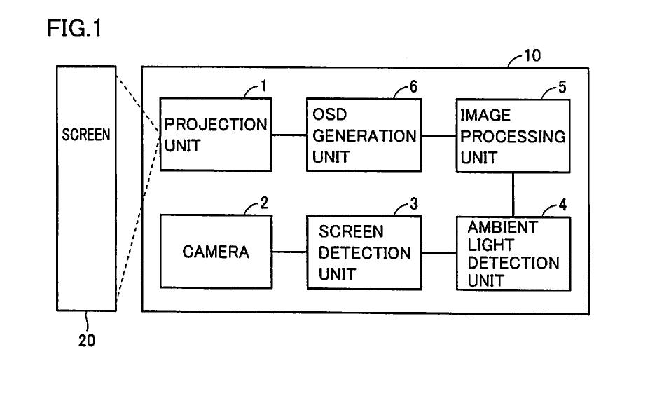

FIG. 1 is a block diagram showing a configuration of a projection-type image display apparatus according to a first embodiment of the present invention. Projection-type image display apparatus 10 shown in FIG. 1 includes a projection unit 1, a camera 2, a screen detection unit 3, an ambient light detection unit 4, an image processing unit 5, and an OSD generation unit 6. Here, projection-type image display apparatus 10 is not limited to a projector that projects an image directly from the front side of a screen 20 which is a projection plane. For example, projection-type image display apparatus 10 may be an ultra short focus projector projecting an image obliquely from below screen 20.

Projection unit 1 projects an image through a lens (not shown) on screen 20. Projection unit 1 is mainly constituted of an image generation unit and a light source. As the image generation unit, for example, an LCD (Liquid Crystal Display), a DMD (Digital Micromirror Device) or the like is used. As the light source, for example, a halogen lamp, a laser light source or the like is used.

Camera 2 is an image capture unit capturing an image projected on screen 20 by projection unit 1. Camera 2 is constituted of a lens, a CCD (Charge Coupled Device), and a photodetector such as CMOS sensor. Here, camera 2 may be an image capture unit configured in any manner as long as the image capture unit is configured to be capable of capturing an image projected on screen 20 by projection unit 1.

Screen detection unit 3 detects the position of screen 20 on which an image is projected by projection unit 1. Screen detection unit 3 detects the position of screen 20 by, for example, performing predetermined processing on an entirely white image projected on screen 20 by projection unit 1 and captured by camera 2. Here, projection-type image display apparatus 10 may not be provided with screen detection unit 3 in the case where projection unit 1 can project an image on screen 20 without detection of the position of screen 20.

Ambient light detection unit 4 detects ambient light which is cast on screen 20, from an image captured by camera 2. Specifically, ambient light detection unit 4 divides the image captured by camera 2 into a plurality of sub-regions, and compares an average brightness of each of the sub-regions with an average brightness of the whole region, to detect ambient light cast on screen 20.

Image processing unit 5 performs predetermined processing on an image projected on screen 20 by projection unit 1 or an image captured by camera 2, in order to allow the interactive capability to properly function. In particular, image processing unit 5 performs predetermined processing in the case where the position of projection-type image display apparatus 10 or screen 20 is not adjusted, or ambient light is still cast on screen 20 in spite of the fact that the position of projection-type image display apparatus 10 or screen 20 has been adjusted.

OSD (On Screen Display) generation unit 6 is a superimposed image generation unit generating, in the form of a superimposed image to be superimposed on an image projected on screen 20, information about detection of ambient light detected by ambient light detection unit 4. OSD generation unit 6 generates information about detection “ambient light has been detected” for example, in the form of a superimposed image to be superimposed on an image projected on screen 20, in order to allow a user to recognize the fact that ambient light is cast on screen 20.

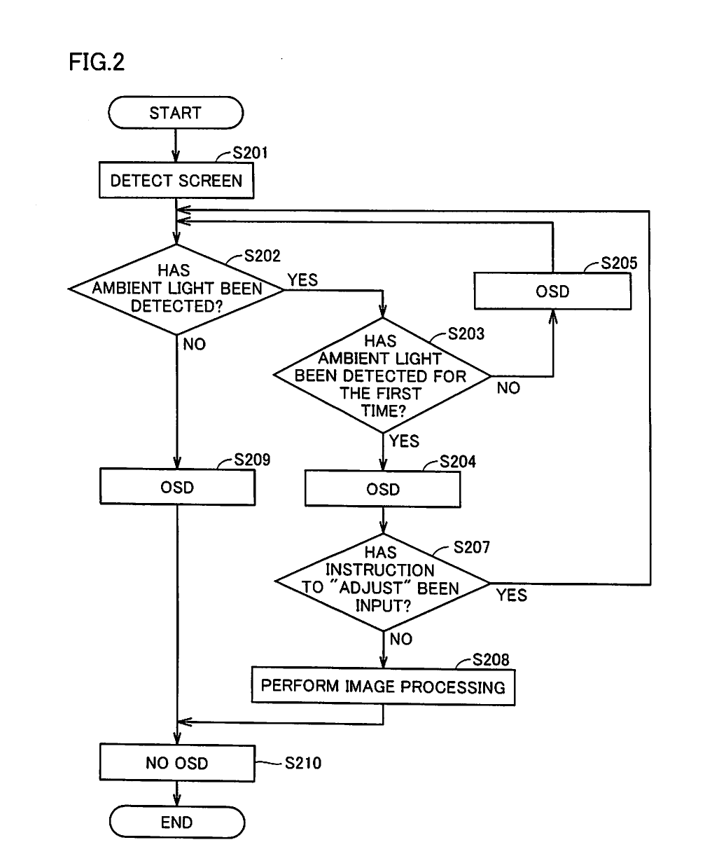

A description will now be given of an operation of detecting ambient light by projection-type image display apparatus 10 according to the first embodiment of the present invention. FIG. 2 is a flowchart showing the operation of detecting ambient light by projection-type image display apparatus 10 according to the first embodiment of the present invention. First, screen detection unit 3 detects the position of screen 20 on which projection unit 1 projects an image (step S201).

Next, ambient light detection unit 4 detects, from an image captured by camera 2, whether or not there is ambient light cast on screen 20 to determine whether or not ambient light is cast on screen 20 (step S202). When ambient light detection unit 4 determines that ambient light is cast on screen 20 (YES in step S202), ambient light detection unit 4 further determines whether or not it is the first time that ambient light detection unit 4 has detected the ambient light cast on screen 20 (step S203).

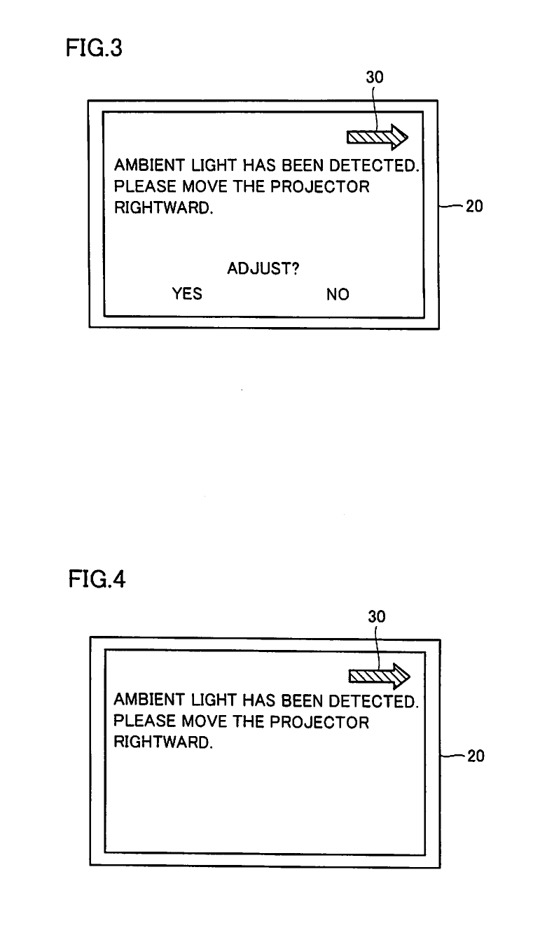

In the case where ambient light detection unit 4 has detected ambient light cast on screen 20 for the first time (YES in step S203), OSD generation unit 6 generates information about detection of the ambient light detected by ambient light detection unit 4, in the form of a superimposed image to be superimposed on an image projected on screen 20, and projection unit 1 projects and displays the superimposed image on screen 20 (step S204). FIG. 3 is an exemplary diagram of the superimposed image displayed in step S204 by projection-type image display apparatus 10 according to the first embodiment of the present invention. The superimposed image shown in FIG. 3 includes a comment “Ambient light has been detected. Please move the projector rightward.” as well as an arrow 30 indicating the direction in which projection-type image display apparatus (projector) 10 is to be moved. Here, the superimposed image also includes a comment “Adjust? YES, NO” which is a message of asking a user to input an answer about whether to adjust the position of projection-type image display apparatus 10 or screen 20.

In the case where the number of times ambient light detection unit 4 has detected ambient light cast on screen 20 is two or more times (NO in step S203), OSD generation unit 6 generates information about detection of the ambient light detected by ambient light detection unit 4, in the form of a superimposed image to be superimposed on an image projected on screen 20, and projection unit 1 projects and displays the superimposed image on screen 20 (step S205). FIG. 4 is an exemplary diagram of the superimposed image displayed in step S205 by projection-type image display apparatus 10 according to the first embodiment of the present invention. Projection-type image display apparatus 10 displays the superimposed image shown in FIG. 4, as an image projected on screen 20. The superimposed image shown in FIG. 4 includes a comment “Ambient light has been detected. Please move the projector rightward.” as well as arrow 30 indicating the direction in which projection-type image display apparatus 10 is to be moved. Projection-type image display apparatus 10 in step S205 displays the superimposed image shown in FIG. 4, and thereafter returns the process to step S202.

The superimposed image which is displayed by being superimposed on an image projected on screen 20 is not limited to the superimposed image shown in FIG. 4. FIG. 5 is another exemplary diagram of the superimposed image displayed in step S205 by projection-type image display apparatus 10 according to the first embodiment of the present invention. The superimposed image shown in FIG. 5 is an image indicating the position where ambient light is cast on screen 20, namely an image of a circle 50 surrounding the ambient light cast on screen 20. Thus, a user can easily adjust the position of projection-type image display apparatus 10 or screen 20 so that the ambient light is not cast on screen 20, while recognizing the position of the ambient light cast on screen 20.

Further, the superimposed image may not be the image indicating the position of ambient light cast on screen 20 shown in FIG. 5, but be an image captured by camera 2. Even when an image captured by camera 2 is used as a superimposed image, a user can still identify the position of ambient light cast on screen 20. Therefore, a user can easily adjust the position of projection-type image display apparatus 10 or screen 20 so that ambient light is not cast on screen 20, while recognizing the position of the ambient light cast on screen 20. Furthermore, in the case where an image captured by camera 2 is used as a superimposed image, it is unnecessary for projection-type image display apparatus 10 to generate an image indicating the position of ambient light cast on screen 20, and therefore the burden of generating the image can be lessened.

Projection-type image display apparatus 10 determines whether or not information has been input that gives an instruction to adjust the position of projection-type image display apparatus 10 or screen 20 for preventing ambient light from being cast on screen 20 (step S207). When projection-type image display apparatus 10 determines that the information has been input that gives an instruction to adjust the position of projection-type image display apparatus 10 or screen 20 for preventing ambient light from being cast on screen 20 (YES in step S207), it returns the process to step S202.

When projection-type image display apparatus 10 determines that the information has not been input that gives an instruction to adjust the position of projection-type image display apparatus 10 or screen 20 for preventing ambient light from being cast on screen 20 (NO in step S207), image processing unit 5 performs predetermined processing on an image to be projected on screen 20 by projection unit 1 or on an image captured by camera 2, so that the interactive capability properly functions (step S208). Specifically, image processing unit 5 converts a predetermined pattern image projected on screen 20 into a predetermined pattern image that avoids the position of ambient light cast on screen 20, based on the information about detection of the ambient light detected by ambient light detection unit 4.

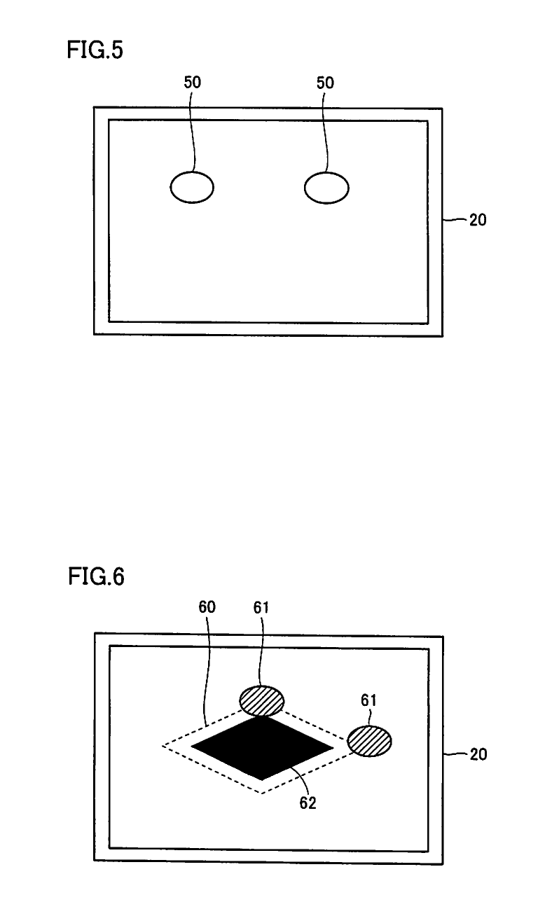

FIG. 6 is an exemplary diagram of an image displayed after undergoing image processing by image processing unit 5 of projection-type image display apparatus 10 according to the first embodiment of the present invention. As shown in FIG. 6, in the case where a rhombic pattern image 60 is projected on screen 20, ambient light 61 cast on screen 20 makes a part of rhombic pattern image 60 indistinct. Due to this, projection-type image display apparatus 10 cannot properly operate the interactive capability (such as contrast adjusting capability for example) by means of rhombic pattern image 60. Accordingly, image processing unit 5 converts rhombic pattern image 60 into a rhombic pattern image 62 that avoids the position of ambient light 61 cast on screen 20, based on the information about detection of ambient light 61 detected by ambient light detection unit 4. Projection-type image display apparatus 10 can use rhombic pattern image 62 generated by the conversion to properly operate the interactive capability. Here, while rhombic pattern image 60 is indicated by a broken line for the sake of convenience, it is similar to rhombic pattern image 62, namely a rhombic pattern image filled in black.

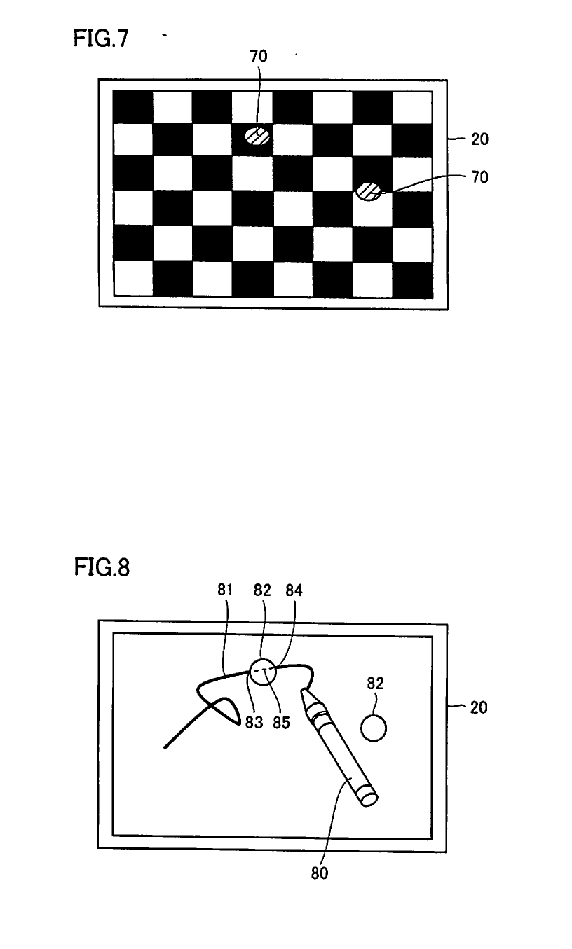

Further, image processing unit 5 may remove, from a predetermined pattern image captured by camera 2, an image located at the position of ambient light cast on screen 20, based on the information about detection of the ambient light detected by ambient light detection unit 4. FIG. 7 is another exemplary diagram of an image displayed after undergoing image processing by image processing unit 5 of projection-type image display apparatus 10 according to the first embodiment of the present invention. In the case as shown in FIG. 7 where a checkered-flag pattern image is projected on screen 20, ambient light 70 cast on screen 20 makes a part of the checkered-flag pattern image indistinct. Due to this, projection-type image display apparatus 10 cannot properly operate the interactive capability (such as autofocus capability for example) by means of the checkered-flag pattern image. Accordingly, image processing unit 5 removes, from the checkered-flag pattern image, an image located at the position of ambient light 70 cast on screen 20, based on the information about detection of ambient light 70 detected by ambient light detection unit 4. Projection-type image display apparatus 10 can use the checkered-flag pattern image from which a part has been removed to thereby properly operate the interactive capability.

Alternatively, image processing unit 5 may complement an image located at the position of ambient light cast on screen 20, based on the information about detection of ambient light detected by ambient light detection unit 4 from the image captured by camera 2. FIG. 8 is still another exemplary diagram of an image displayed after undergoing image processing by image processing unit 5 of projection-type image display apparatus 10 according to the first embodiment of the present invention.

In the case as shown in FIG. 8 where a track 81 of a pointing device 80 that is captured by camera 2 is generated in the form of a superimposed image, ambient light 82 cast on screen 20 hinders pointing device 80 from being recognized. Thus, projection-type image display apparatus 10 provides a superimposed image of discontinuous track 81 of pointing device 80. Accordingly, based on the image captured by camera 2 and the information about detection of ambient light 82 detected by ambient light detection unit 4, image processing unit 5 complements the track extending from an entry point 83 to an exit point 84 of pointing device 80 that is located at the position of ambient light 82 cast on screen 20, with an image of a straight line 85 indicated here by a broken line. Projection-type image display apparatus 10 can complement the image located at the position of ambient light cast on screen 20 to thereby properly operate the interactive capability.

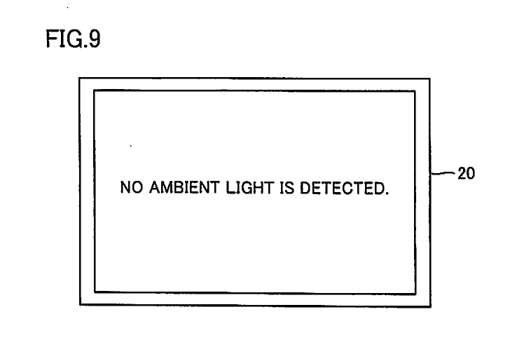

Referring back to FIG. 2, when ambient light detection unit 4 determines that no ambient light is cast on screen 20 (NO in step S202), OSD generation unit 6 generates information about detection of ambient light detected by ambient light detection unit 4, in the form of a superimposed image to be superimposed on an image projected on screen 20, and projection unit 1 projects and displays the superimposed image on screen 20 (step S209). FIG. 9 is an exemplary diagram of the superimposed image displayed in step S209 by projection-type image display apparatus 10 according to the first embodiment of the present invention. The superimposed image shown in FIG. 9 includes a comment “No ambient light is detected.”

Next, projection-type image display apparatus 10 displays the superimposed image shown in FIG. 9 for a certain period of time and thereafter presents no OSD, namely the superimposed image is not displayed (step S210). Even in the case where the superimposed image shown in FIG. 3 is displayed, projection-type image display apparatus 10 presents no OSD, namely the superimposed image is not displayed (step S210), after the process in step S208.

As heretofore described, projection-type image display apparatus 10 according to the first embodiment of the present invention generates, by OSD generation unit 6, information about detection of ambient light detected by ambient light detection unit 4, in the form of a superimposed image to be superimposed on an image projected on screen 20. Thus, a user can easily know whether or not ambient light is cast on screen 20. The user can therefore easily adjust, based on the superimposed image, the position of projection-type image display apparatus 10 or screen 20 so that no ambient light is cast on screen 20. Here, the operation of detecting ambient light by projection-type image display apparatus 10 shown in FIG. 2 is not limited to the operation including the step of determining whether or not it is the first time that ambient light detection unit 4 has detected ambient light cast on screen 20, namely the operation may not include this step.

### Second Embodiment

A projection-type image display apparatus according to a second embodiment of the present invention is configured identically to projection-type image display apparatus 10 shown in FIG. 1, and therefore, the detailed description thereof will not be repeated. A description will now be given of an operation of detecting ambient light by projection-type image display apparatus 10 according to the second embodiment of the present invention.

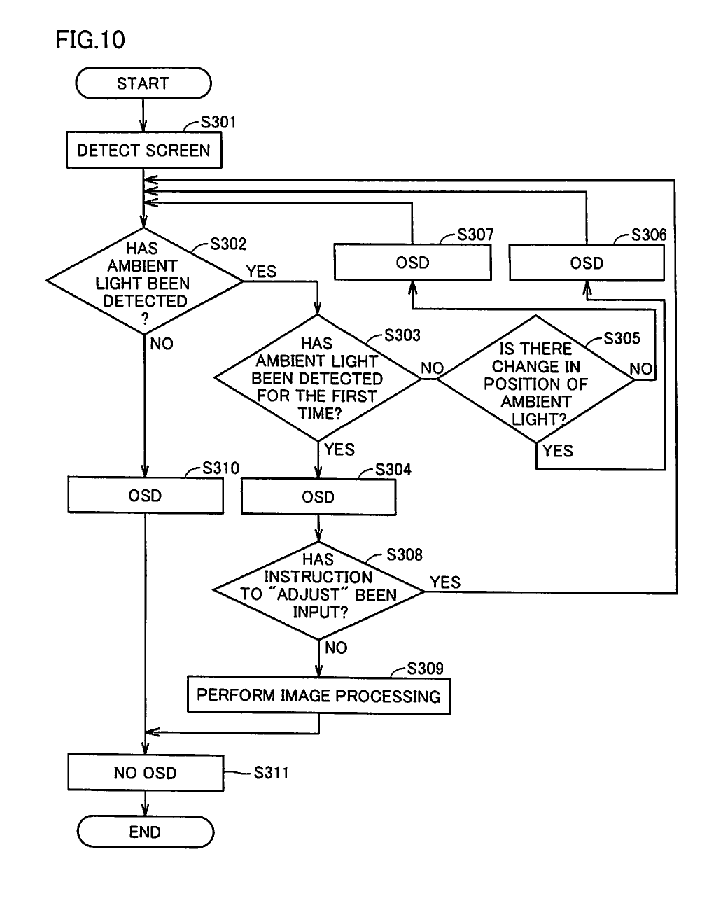

FIG. 10 is a flowchart showing the operation of detecting ambient light by projection-type image display apparatus 10 according to the second embodiment of the present invention. First, screen detection unit 3 detects the position of screen 20 on which an image is projected by projection unit 1 (step S301).

Next, ambient light detection unit 4 detects, from an image captured by camera 2, whether or not there is ambient light cast on screen 20 to determine whether or not ambient light is cast on screen 20 (step S302). When ambient light detection unit 4 determines that ambient light is cast on screen 20 (YES in step S302), ambient light detection unit 4 further determines whether or not it is the first time that ambient light detection unit 4 has detected the ambient light cast on screen 20 (step S303).

In the case where it is the first time that ambient light detection unit 4 has detected ambient light cast on screen 20 (YES in step S303), OSD generation unit 6 generates information about detection of the ambient light detected by ambient light detection unit 4, in the form of a superimposed image to be superimposed on an image projected on screen 20, and projection unit 1 projects and displays the superimposed image on screen 20 (step S304). In step S304, projection-type image display apparatus 10 displays the superimposed image shown in FIG. 3, as an image projected on screen 20.

In the case where the number of times ambient light detection unit 4 has detected ambient light cast on screen 20 is two or more times (NO in step S303), ambient light detection unit 4 determines whether or not there is a change in position of the ambient light detected this time, relative to the position of the ambient light detected last time (step S305). When ambient light detection unit 4 determines that there is a change in position of the ambient light detected this time relative to the position of the ambient light detected last time (YES in step S305), OSD generation unit 6 generates information about detection of the ambient light detected by ambient light detection unit 4, in the form of a superimposed image to be superimposed on an image projected on screen 20, and projection unit 1 projects and displays the superimposed image on screen 20 (step S306). In step S306, projection-type image display apparatus 10 displays the superimposed image shown in FIG. 4, as an image projected on screen 20. Projection-type image display apparatus 10 displays the superimposed image shown in FIG. 4 in step S306, and thereafter returns the process to step S302.

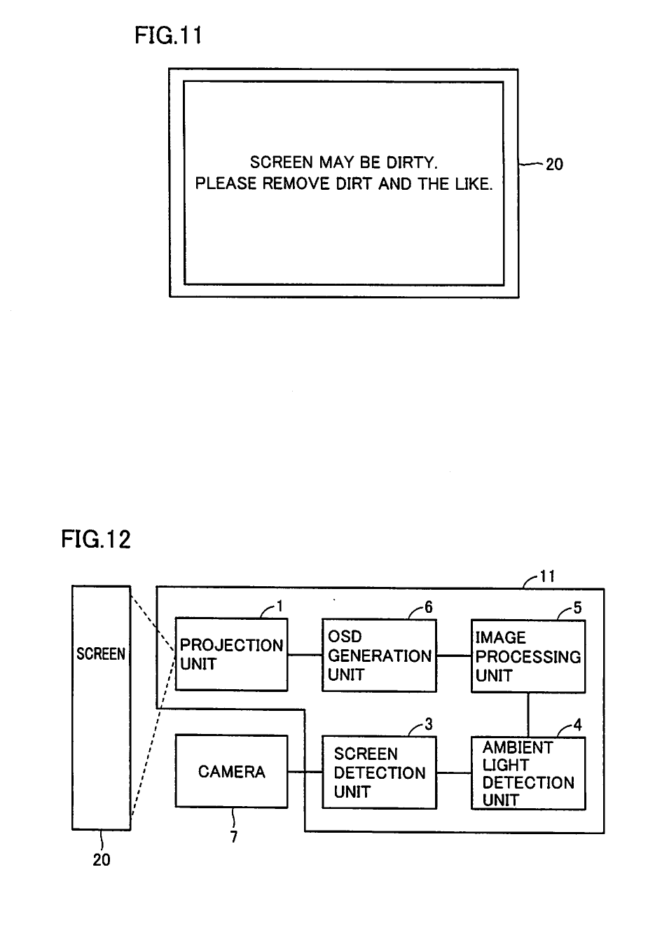

When ambient light detection unit 4 determines that the position of ambient light detected this time remains unchanged relative to the position of the ambient light detected last time (NO in step S305), in spite of the fact that the position of projection-type image display apparatus 10 or screen 20 has been adjusted so that ambient light is not cast on screen 20, it determines that what is detected as ambient light this time is caused by disturbance of reflection of light by dirt sticking to screen 20 or by magnet or the like attached to screen 20. Then, OSD generation unit 6 generates information about detection of ambient light detected by ambient light detection unit 4, in the form of a superimposed image superimposed on an image displayed on screen 20, and projection unit 1 projects and displays the superimposed image on screen 20 (step S307). FIG. 11 is an exemplary diagram of the superimposed image displayed in step S307 by projection-type image display apparatus 10 according to the second embodiment of the present invention. The superimposed image shown in FIG. 11 includes a comment “Screen may be dirty. Please remove dirt and the like.” In step S307, projection-type image display apparatus 10 displays the superimposed image shown in FIG. 11, and thereafter returns the process to step S302.

Projection-type image display apparatus 10 determines whether or not information has been input that gives an instruction to adjust the position of projection-type image display apparatus 10 or screen 20 for preventing ambient light from being cast on screen 20 (step S308). When projection-type image display apparatus 10 determines that the information has been input that gives an instruction to adjust the position of projection-type image display apparatus 10 or screen 20 for preventing ambient light from being cast on screen 20 (YES in step S308), it returns the process to step S302.

When projection-type image display apparatus 10 determines that the information has not been input that gives an instruction to adjust the position of projection-type image display apparatus 10 or screen 20 for preventing ambient light from being cast on screen 20 (NO in step S308), image processing unit 5 performs predetermined processing on an image to be projected on screen 20 by projection unit 1 or on an image captured by camera 2, so that the interactive capability properly functions (step S309).

When ambient light detection unit 4 determines that no ambient light is cast on screen 20 (NO in step S302), OSD generation unit 6 generates information about detection of ambient light detected by ambient light detection unit 4, in the form of a superimposed image to be superimposed on an image projected on screen 20, and projection unit 1 projects and displays the superimposed image on screen 20 (step S310). In S310, projection-type image display apparatus 10 displays the superimposed image shown in FIG. 9, as an image projected on screen 20.

Then, projection-type image display apparatus 10 displays the superimposed image shown in FIG. 9 for a certain period of time, and thereafter presents no OSD, namely the image is not displayed (step S311). Even in the case where the superimposed image shown in FIG. 3 is displayed, projection-type image display apparatus 10 presents no OSD, namely the superimposed image is not displayed, after the process in step S309 (step S311).

As heretofore described, projection-type image display apparatus 10 according to the second embodiment of the present invention determines, by ambient light detection unit 4, whether or not the position of the ambient light detected this time is different from the position of the ambient light detected last time. Thus, it can be determined that dirt sticking to screen 20, or magnet or the like attached to screen 20 disturbs reflection of light and this is detected as ambient light.

### Third Embodiment

FIG. 12 is a block diagram showing a configuration of a projection-type image display apparatus according to a third embodiment of the present invention. Projection-type image display apparatus 11 shown in FIG. 12 includes projection unit 1, screen detection unit 3, ambient light detection unit 4, image processing unit 5, and OSD generation unit 6. Regarding projection-type image display apparatus 11, a camera 7 capturing an image projected on screen 20 by projection unit 1 is attached to the outside of projection-type image display apparatus 11. Projection-type image display apparatus 11 is configured identically to projection-type image display apparatus 10 shown in FIG. 1 except that camera 7 is attached to the outside. Therefore, the same components are denoted by the same reference characters, and the detailed description thereof will not be repeated. While FIG. 12 shows the configuration of projection-type image display apparatus 11 in which camera 2 is not contained, camera 7 may be attached to the outside of projection-type image display apparatus 11 which contains camera 2.

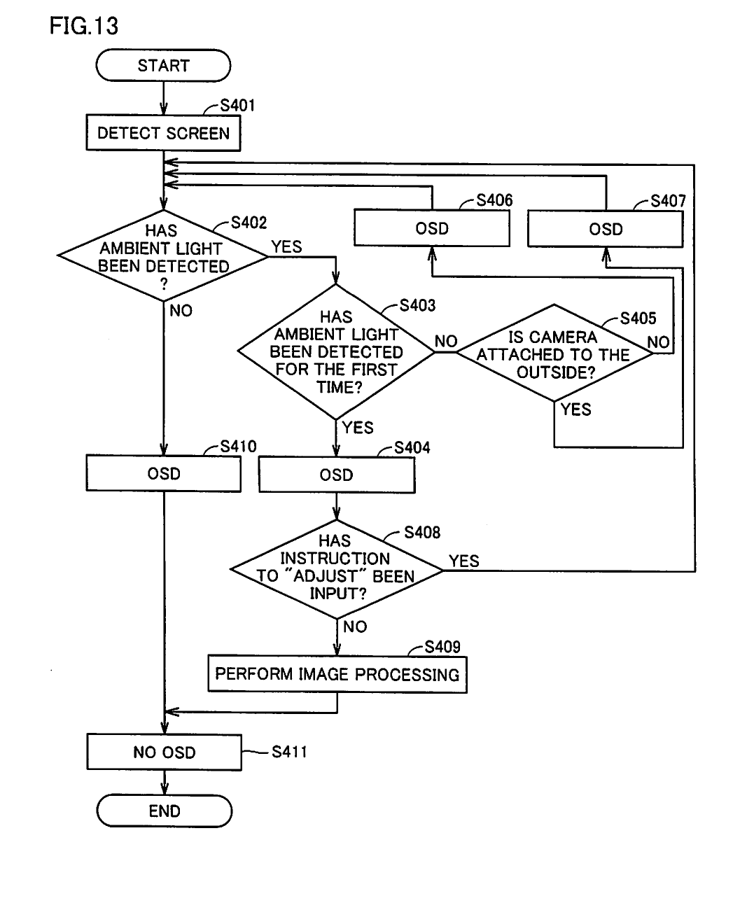

A description will be given of an operation of detecting ambient light by projection-type image display apparatus 11 according to the third embodiment of the present invention. FIG. 13 is a flowchart showing the operation of detecting ambient light by projection-type image display apparatus 11 according to the third embodiment of the present invention. First, screen detection unit 3 detects the position of screen 20 on which an image is projected by projection unit 1 (step S401).

Next, ambient light detection unit 4 detects, from an image captured by camera 7, whether or not there is ambient light cast on screen 20 to determine whether or not ambient light is cast on screen 20 (step S402). When ambient light detection unit 4 determines that ambient light is cast on screen 20 (YES in step S402), ambient light detection unit 4 further determines whether or not it is the first time that ambient light detection unit 4 has detected ambient light cast on screen 20 (step S403).

In the case where it is the first time that ambient light detection unit 4 has detected ambient light cast on screen 20 (YES in step S403), OSD generation unit 6 generates information about detection of the ambient light detected by ambient light detection unit 4, in the form of a superimposed image to be superimposed on an image projected on screen 20, and projection unit 1 projects and displays the superimposed image on screen 20 (step S404). In step S404, projection-type image display apparatus 11 displays the superimposed image shown in FIG. 3, as an image superimposed on screen 20.

In the case where the number of times ambient light detection unit 4 has detected ambient light cast on screen 20 is two or more times (NO in step S403), it is determined whether or not camera 7 is attached to the outside of projection-type image display apparatus 11 (step S405). An information flag may change in response to attachment of camera 7 to the outside of projection-type image display apparatus 11, for example. Ambient light detection unit 4 may detect this change and determine that camera 7 is attached to the outside of projection-type image display apparatus 11.

When ambient light detection unit 4 determines that camera 7 is not attached to the outside of projection-type image display apparatus 11 (NO in step S405), OSD generation unit 6 generates information about detection of the ambient light detected by ambient light detection unit 4, in the form of a superimposed image to be superimposed on an image projected on screen 20, and projection unit 1 projects and displays the superimposed image on screen 20 (step S406). It is supposed here that projection-type image display apparatus 11 contains camera 2 (not shown). In step 5406, projection-type image display apparatus 11 displays the superimposed image shown in FIG. 4, as an image projected on screen 20. Projection-type image display apparatus 11 displays the superimposed image shown in FIG. 4 in step S406 and thereafter returns the process to step S402.

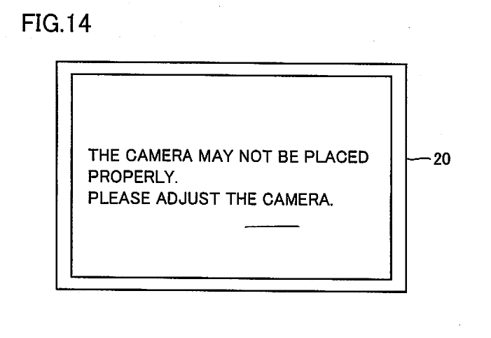

When ambient light detection unit 4 determines that camera 7 is attached to the outside of projection-type image display apparatus 11 (YES in step S405), it determines that the position of camera 7 attached to the outside of projection-type image display apparatus 11 causes ambient light to be cast on screen 20 in spite of the fact that the position of projection-type image display apparatus 11 or screen 20 has been adjusted. Then, OSD generation unit 6 generates information about detection of the ambient light detected by ambient light detection unit 4, in the form of a superimposed image superimposed on an image projected on screen 20, and projection unit 1 projects and displays the superimposed image on screen 20 (step S407). FIG. 14 is an exemplary diagram of the superimposed image displayed in step S407 by the projection-type image display apparatus according to the third embodiment of the present invention. The superimposed image shown in FIG. 14 includes a comment “The camera may not be placed properly. Please adjust the camera.” Projection-type image display apparatus 11 displays the superimposed image shown in FIG. 14 in step S407, and thereafter returns the process to step S402.

Projection-type image display apparatus 11 determines whether or not information has been input that gives an instruction to adjust the position of projection-type image display apparatus 11 or screen 20 for preventing ambient light from being cast on screen 20 (step S408). When projection-type image display apparatus 11 determines that the information has been input that gives an instruction to adjust the position of projection-type image display apparatus 11 or screen 20 for preventing ambient light from being cast on screen 20 (YES in step S408), it returns the process to step S402.

When projection-type image display apparatus 11 determines that the information has not been input that gives an instruction to adjust the position of projection-type image display apparatus 11 or screen 20 for preventing ambient light from being cast on screen 20 (NO in step S408), image processing unit 5 performs predetermined processing on an image to be projected on screen 20 by projection unit 1 or on an image captured by camera 7, so that the interactive capability properly functions (step S409).

When ambient light detection unit 4 determines that no ambient light is cast on screen 20 (NO in step S402), OSD generation unit 6 generates information about detection of ambient light detected by ambient light detection unit 4, in the form of a superimposed image to be superimposed on an image projected on screen 20, and projection unit 1 projects and displays the superimposed image on screen 20 (step S410). In step S410, projection-type image display apparatus 11 displays the superimposed image shown in FIG. 9, as an image projected on screen 20.

Next, projection-type image display apparatus 11 displays the superimposed image shown in FIG. 9 for a certain period of time and thereafter presents no OSD, namely the superimposed image is not displayed (step S411). Even in the case where the superimposed image shown in FIG. 3 is displayed, projection-type image display apparatus 11 presents no OSD, namely the superimposed image is not displayed, after the process in step S409 (step S411).

As heretofore described, projection-type image display apparatus 11 according to the third embodiment of the present invention determines, by ambient light detection unit 4, whether or not camera 7 is attached to the outside of projection-type image display apparatus 11. Thus, it can be determined that the reason why ambient light is cast on screen 20 in spite of the fact that the position of projection-type image display apparatus 11 or screen 20 has been adjusted, is the position of camera 7 attached to the outside of projection-type image display apparatus 11.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A projection-type image display apparatus projecting an image on a projection plane, comprising:
a projection unit projecting an image on said projection plane through a lens;
an image capture unit capturing the image projected on said projection plane by said projection unit;
an ambient light detection unit detecting ambient light cast on said projection plane, from the image captured by said image capture unit; and
a superimposed image generation unit generating information about detection of ambient light detected by said ambient light detection unit, in the form of a superimposed image to be superimposed on the image projected on said projection plane.

2. The projection-type image display apparatus according to claim 1, wherein said superimposed image generation unit generates an image indicating a position of ambient light cast on said projection plane, in the form of said superimposed image.

3. The projection-type image display apparatus according to claim 1, wherein said superimposed image generation unit generates an image captured by said image capture unit, in the form of said superimposed image.

4. The projection-type image display apparatus according to claim 1, further comprising an image processing unit converting a predetermined pattern image projected on said projection plane into said predetermined pattern image that avoids a position of ambient light cast on said projection plane, based on said information about detection of ambient light detected by said ambient light detection unit.

5. The projection-type image display apparatus according to claim 1, further comprising an image processing unit removing an image located at a position of ambient light cast on said projection plane from a predetermined pattern image captured by said image capture unit, based on said information about detection of ambient light detected by said ambient light detection unit.

6. The projection-type image display apparatus according to claim 1, further comprising an image processing unit complementing an image located at a position of ambient light cast on said projection plane, based on an image captured by said image capture unit and said information about detection of ambient light detected by said ambient light detection unit.
